(19) United States
(12) Patent Application Publication
(10) Pub. No.: US 2023/0034199 A1
(43) Pub. Date: Feb. 2, 2023

(54) METHOD FOR WINDING A STATOR OF A BRUSHLESS DIRECT CURRENT MOTOR

(71) Applicant: Nidec Corporation, Kyoto (JP)

(72) Inventors: Jürgen SCHMID, Brackenheim (DE); Thomas KÜBLER, Untergruppenbach (DE)

(21) Appl. No.: 17/787,005

(22) PCT Filed: Dec. 9, 2020
(86) PCT No.: PCT/IB2020/061670

§ 371 Date: Jun. 17, 2022

(30) Foreign Application Priority Data
Dec. 18, 2019 (DE) 10 2019 134 934.6

(51) Int. Cl. H02K 15/095; H02K 3/28

(52) U.S. Cl. CPC H02K 15/095; H02K 3/28

(57) ABSTRACT

A method of winding a stator of a polyphase brushless DC motor, the stator including uniformly spaced stator teeth which project inwardly from a stator core and leave a cylindrical inner region exposed. The teeth are wound in pairs with a winding wire to form a winding pair, the winding of each winding pair being performed by, starting from a wire beginning of a winding wire, winding a first stator tooth in a first direction, guiding the winding wire to a second stator tooth which immediately follows the first stator tooth in a first circumferential direction, and winding the second stator tooth in a second direction opposite to the first direction. The winding pairs are structured to be supplied with current so that a north pole and a south pole are opposite each other in the stator in the circumferential direction.

### CROSS REFERENCE TO RELATED APPLICATION

This is a U.S. national stage of PCT Application No. PCT/IB2020/061670, filed on Dec. 9, 2020, and with priority under 35 U.S.C. § 119(a) and 35 U.S.C. § 365(b) being claimed from German Application No. 10 2019 134 934.6, filed on Dec. 18, 2019, the entire contents of which are hereby incorporated herein by reference.

### 1. FIELD OF THE INVENTION

The present disclosure relates to a method of winding a stator of a brushless DC motor, a stator for a brushless DC motor, and a method of manufacturing an electric motor.

### 2. BACKGROUND

Brushless DC motors of the type relevant here are referred to as internal rotor motors and have a rotor which is connected to a motor shaft and is rotatably mounted in a housing. The rotor is provided with permanent magnets. A stator is arranged around the motor, which carries a number of windings on an iron core. When suitably controlled, the windings generate a magnetic field that drives the rotor to rotate. The windings are usually wound in three phases and are accordingly provided with three electrical connections via which the windings can be connected to a control unit (ECU).

For the purpose of the geometrical description of the electric motor, firstly, the axis of rotation of the motor is assumed to be the center axis and axis of symmetry. The stator is concentric with the axis of rotation and the rotor. The axis of rotation defines an axial direction at the same time. In addition, with respect to the center axis, a radial direction is spoken of, which indicates the distance from the center axis, as well as a circumferential direction, which is defined tangentially to a certain radius arranged in the radial direction.

It is known to realize the stator winding of a brushless three-phase electric motor in terms of a delta connection. A conventional design of the stator requires two different versions of the tooth pair winding. These are then mounted alternately in the stator. In the case of each coil pair, the loose coil end in the winding space is adjacent to the coil end of a coil pair of another phase. This creates the risk of an electrical short circuit between two phases. Another disadvantage of the winding scheme is the arrangement of the wire ends to be connected to each other. These are at an angle of approximately 180°. A busbar unit with busbars, which is required for contacting the wire ends of the stator, requires one layer of busbar each for contacting the wire ends, which has a negative effect on the axial extension of the busbar holder and thus of the electric motor.

### SUMMARY

Example embodiments of the present disclosure provide methods of windings stator of brushless DC motors which each achieve increased or optimized quality by reducing the risk of an electrical short circuit between phases and which each reduce an axial extension of a stator pack and thus also an overall height of the electric motor in an axial direction.

Accordingly, an example embodiment of the present disclosure provides a method of winding a stator of a polyphase brushless DC motor. The stator includes uniformly spaced stator teeth which project inwardly from a stator core and leave a cylindrical inner region free, the stator teeth being wound in pairs with a winding wire to form a pair of windings. The method of winding of each pair of windings includes, starting from a wire beginning of a winding wire, winding a first stator tooth in a first direction, guiding the winding wire to a second stator tooth immediately following the first stator tooth in a first circumferential direction, and winding the second stator tooth in a second direction opposite to the first direction.

The winding pairs are structured to be supplied with current in such a way that a direction of current flow through winding pairs opposite each other in a circumferential direction is reversed, so that a north pole and a south pole are opposite each other in the stator in the circumferential direction.

The first direction and the corresponding winding directions are the same for each pair of windings.

The winding schemes according to example embodiments of the present disclosure has the advantage that the winding of each pair of teeth is the same and thus different components can be avoided, which in turn saves costs. Furthermore, the risk of an electrical short-circuit between the phases is significantly reduced, since crossing of the wires is avoided.

It is preferred if each pair of windings is wound with a single winding wire. However, it is also possible to wind at least two pairs of windings with a single winding wire to form a coil chain.

In one example embodiment, the stator includes six pairs of windings.

Furthermore, a stator for a brushless DC motor is provided with a stator core and stator teeth which are evenly spaced in the circumferential direction, project inwards from the stator core, and leave a cylindrical inner region free. The stator teeth are wound in pairs with a winding wire to define a winding pair according to the method described above. This results in the great advantage that winding can be carried out with a single winding scheme during the winding process. Thus, for example, a six-spindle winding machine can be used.

Also provided is an example embodiment of a method of manufacturing a polyphase brushless DC motor including a stator and an inner rotor. The stator includes uniformly spaced stator teeth projecting inwardly from a stator core and leaving a cylindrical inner region free. The stator teeth are wound in pairs with a winding wire to form a pair of windings, the winding of each pair of windings including, starting from a wire beginning of a winding wire, winding a first stator tooth in a first direction, guiding the winding wire to a second stator tooth immediately following the first stator tooth in a first circumferential direction, and winding the second stator tooth in a second direction opposite to the first direction. The method further includes, after winding all pairs of windings, performing electrically conductive contacting of the winding wire ends of the winding pairs to a contacting device, which is energized in operation in such a way that the direction of the current flow through winding pairs opposing each other in the circumferential direction is reversed, so that a north pole and a south pole are opposite each other in the stator in the circumferential direction.

The first direction and the corresponding winding directions are the same for each pair of windings.

This winding scheme has the advantage that the winding of each pair of teeth is the same and thus different components can be avoided, which in turn saves costs. Since the winding process involves a single winding scheme, a six-spindle winding machine can be used, for example. Furthermore, the risk of an electrical short-circuit between the phases is significantly reduced, since crossing of the wires is avoided.

It is preferred if each pair of windings is wound with a single winding wire. However, it is also possible to wind at least two pairs of windings with a single winding wire to form a coil chain.

In one example embodiment, the stator includes six pairs of windings. In this case, it is advantageous if the winding wire ends to be connected extend over a circle sector of about 150° to form a phase. The contacting device can be a busbar assembly. Contacting via busbars can thus be much more compact.

Preferably, the internal rotor includes 10 poles. In an example embodiment, the electric motor is three-phase.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 shows a schematic diagram of a stator in a plan view with winding scheme according to an example embodiment of the present disclosure.

FIG. 2 shows another schematic representation of the wound stator in a plan view.

FIG. 3 shows a schematic representation of the stator of FIG. 2 with busbars.

FIG. 4 shows a schematic representation of the power source connections of the three busbars shown in FIG. 3.

FIG. 5 shows a longitudinal section through a schematically shown electric motor with stator and busbars according to an example embodiment of the present disclosure.

### DETAILED DESCRIPTION

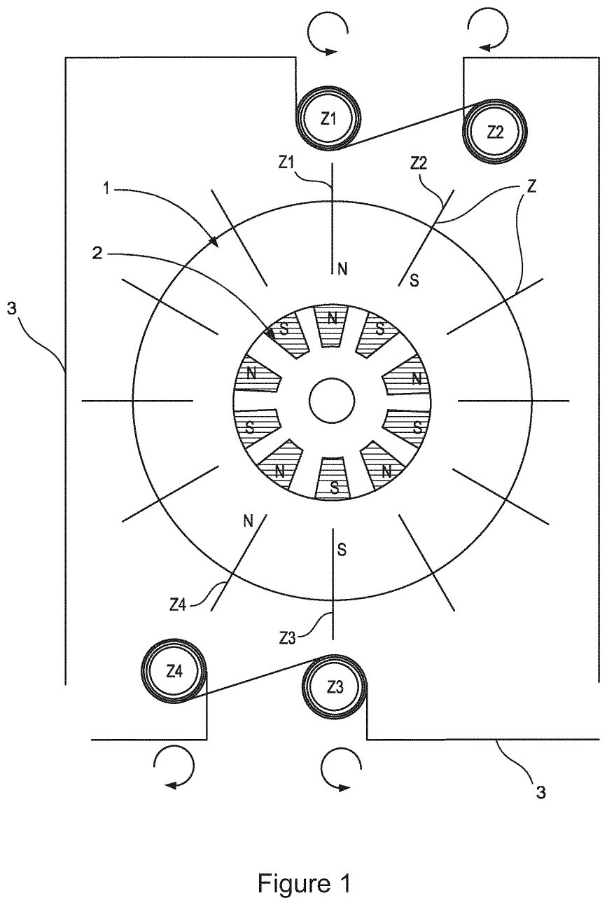

FIG. 1 schematically shows a stator 1 of a brushless DC motor surrounding a rotor 2. The stator 1 has 12 stator slots and thus 12 stator teeth Z spaced apart. The rotor 2 has 10 poles. A three-phase electric motor is to be realized in which the three phase strings of the stator winding are in the form of a delta connection. FIG. 1 shows an example of the winding scheme for four teeth Z1, Z2, Z3 and Z4. Clockwise two stator teeth Z1,Z2 directly following each other are wound one after the other starting from a wire beginning 3 forming two coils. In other words, two stator teeth Z1,Z2 separated by a single slot are wound one after the other in a single operation. The winding scheme is shown schematically. The arrows indicate the winding direction. The winding wire is wound counterclockwise onto the first stator tooth Z1. Once this first stator tooth Z1 is wound, the winding wire is guided to the following second stator tooth Z2 in clockwise direction and there wound around the second stator tooth Z2 in clockwise direction. The same is done with a further winding wire or wire beginning 3 for the two further stator teeth Z3,Z4, which are opposite the first winding pair in circumferential direction. Here, too, the first tooth Z3 is wound counterclockwise and the tooth Z4 following in the circumferential direction is wound clockwise. The necessary reversal of the magnetic poles is achieved by an inverted electrical connection, i.e. the circumferentially opposite winding pairs are energized in such a way that the current flows in opposite directions.

The coils of the other phases are formed with the same winding scheme.

Thus, winding is performed according to the same pattern for each tooth pair Z1,Z2 and Z3,Z4. It is also conceivable that a coil chain is wound, i.e. pairs of teeth are wound one after the other without interruption with alternating winding direction between adjacent teeth.

The winding scheme has the advantage that the winding of each pair of teeth is the same and thus different components can be avoided, which in turn saves costs. Furthermore, the risk of an electrical short-circuit between the phases is significantly reduced, since crossing of the wires is avoided. The wire ends to be connected to each other are at an angle of approximately 150°, which means that a busbar assembly can be designed in only two layers instead of three, and thus has a significantly more compact structure.

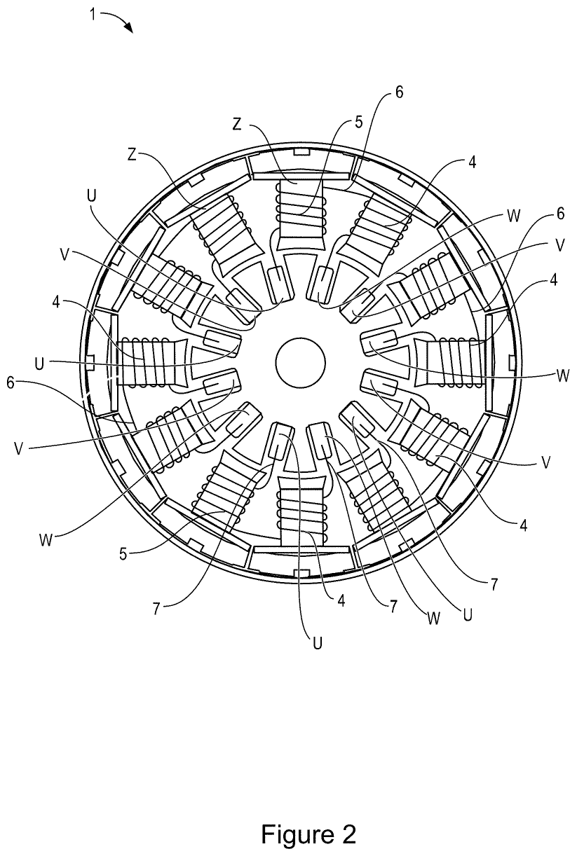

FIG. 2 shows the fully wound stator 1. The stator 1 of the electric motor consists of an iron core and has three phase windings 5 built up from several coils 4 on the poles to form a four-pole motor, with the coils 4 wound on the respective poles. The stator teeth Z extend inwardly from the iron core, leaving a cylindrical inner region within which the rotor of the motor, not shown, rotates during operation. The three phases U,V,W are formed by interconnected pairs of windings 6, so that two parallel current paths are created in a delta circuit. As already described for FIG. 1, a first coil of each winding pair 6 is formed by winding a tooth counterclockwise. This is followed without interruption by the winding of a second tooth of the winding pair 6 immediately adjacent in clockwise direction to the first tooth, which is wound clockwise. The winding wire ends 7 of the winding pairs 6 are electrically contacted towards the center of the stator. All six winding pairs 6 are wound according to the same scheme. The necessary reversal of the magnetic pole between two winding pairs 6 of one phase U,V,W is achieved by an inverted electrical connection and a reversal of the direction of the current flow. The wire ends 7 to be connected to each other are thus at an angle of approximately 150°. The respective contacts of a phase are distributed over a range of approximately 210°.

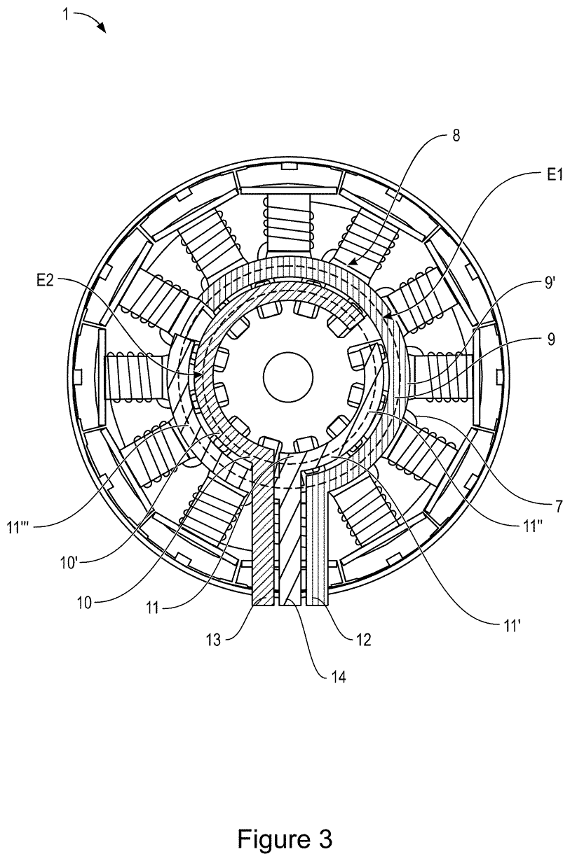

FIG. 3 shows a schematic top view of a busbar assembly 8 of the stator 1 shown in FIG. 1. The busbar assembly 8 comprises a busbar holder not shown and three busbars 9, 10, 11 mounted on the busbar holder. The busbars 9, 10, 11 are made of an electrically conductive material, preferably metal, in particular copper. The busbar holder consists at least partially or completely of an electrically insulating material, so that short circuits between the busbars 9,10,11 can be effectively prevented. The busbar holder is preferably manufactured by injection molding and extends over a part of the busbars 9,10,11. In this way, a fixed and well-defined physical connection between the busbar holder and the busbars 9,10,11 can be provided. The busbar holder is adapted to be positioned on an axial side of the stator (top side).

The busbar assembly 8 is arranged to electrically contact the coils 4 of the stator 1 by means of the busbars 9,10,11. The coils 4 are grouped in the three phase groups U, V, W. Four winding wire end sections 7 each contact a busbar. The busbar of one phase extends over a range of 210°. Each of the busbars 9,10,11 has a power source connection terminal 12,13,14 adapted to electrically connect the busbar 9,10,11 to a power source.

The busbars 9,10,11 are each arranged with a base section 9′,10′,11′ along the circumference with a fixed radius. The base sections 9′,10′,11′ are shaped like ring segments.

In the illustration of FIG. 3, the busbars 9,10,11 appear to be on different radii to show the arrangement of the busbars 9,10,11 on different planes. This arrangement of busbars 9,10,11 is described below.

A first busbar 9 extends over a range of approximately 210° with its base section 9′ along the circumference. This first busbar lies in a first plane E1. It has the power source connection terminal 12 at one end of the base section 9′. Starting from the power source connection terminal 12, the base section 9′ extends in a clockwise direction. A second bus bar 10 also extends with its base section 10′ over a range of about 210° along the circumference with the same radius as the first bus bar. The second busbar lies in a second plane E2. It has the power source connection 13 at one end of the base section 10′. Starting from the power source connection port 13, the base section 10′ extends counterclockwise. In plan view, the two busbars 9,10 are arranged overlapping at their ends remote from the power source. The two planes E1 and E2 are selected in such a way that, although the ends lie one above the other in the axial direction, they do not touch and are electrically insulated from one another. The two busbars are spaced apart by a distance a in the axial direction.

The third busbar 11 has a power source connection terminal 14 located circumferentially between the terminals 12,13 of the first and second busbars 9,10. All three terminals 12,13,14 are in close proximity to each other. Starting from the third power source connection 14, the third busbar 11 extends in a first region 11″ towards the first busbar 9 on the second level E2 and in a second region 11′″ towards the second busbar 10 on the first level E1. Thus, in plan view, the third busbar 11 is arranged in the first area 11″ overlapping with the first busbar 9 and in the second area 11′″ overlapping with the second busbar 10. Each of the areas 11″, 11′″ extends in the manner of a ring segment over approximately 105°.

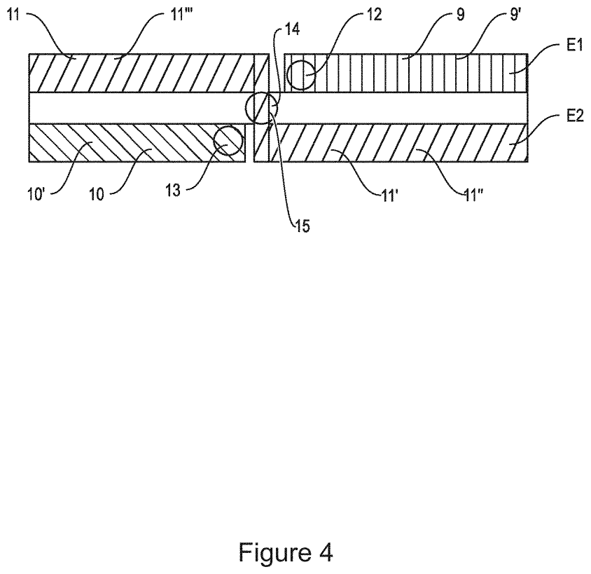

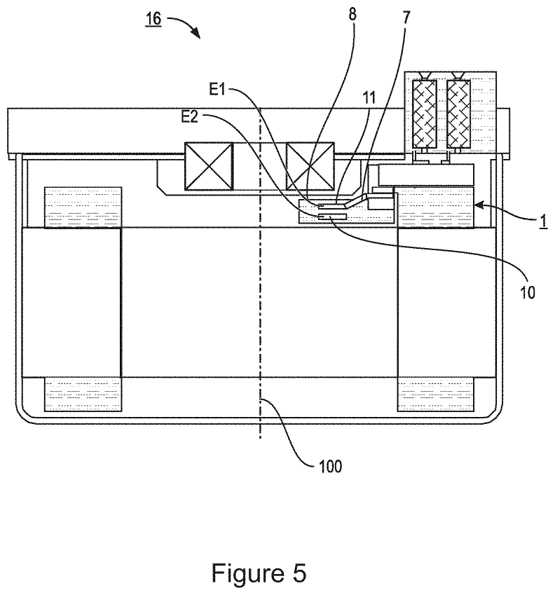

FIGS. 4 and 5 show the arrangement of the busbars 9,10,11 in the axial direction 100. As shown in FIG. 4, the third busbar 11 changes plane halfway along the base section 11′. The base section of the third busbar is thus divided between the two sections 11″,11″. Thus, the third bus bar 11 has a step 15 in the base section 11′. The power source connection terminal 12 of the first busbar 9 is located in the first plane E1, the power source connection terminal 13 of the second busbar 10 is located in the second plane E2, and the power source connection terminal 14 of the third busbar 11 is located between the two planes E1,E2 in the axial direction. The three busbars 9,10,11 are distributed over only two planes E1,E2. The axial extent of the stator pack and thus also the overall height of the electric motor in the axial direction are therefore kept to a minimum in order to save installation space.

FIG. 5 schematically shows an electric motor 16 with stator 1, which carries the busbar assembly 8 on its end face. The busbars 10,11 lie in two different planes E1,E2. The third busbar 11 is in contact with a winding wire end section 7 of the associated coil.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-11. (canceled)

12. A method of winding a stator of a polyphase brushless DC motor, the stator including uniformly spaced stator teeth which project inwardly from a stator core and leave a cylindrical inner region free, the stator teeth being wound in pairs with a winding wire to form a pair of windings, the method comprising winding each of the pair of windings by:
starting from a wire beginning of the winding wire, winding a first stator tooth in a first direction;
guiding the winding wire to a second stator tooth which immediately follows the first stator tooth in a first circumferential direction; and
winding the second stator tooth in a second direction opposite to the first direction; wherein
the first direction and corresponding winding directions are the same for each pair of windings on the first stator tooth and the second stator tooth, and the pairs of windings are structured to be supplied with current such that the direction of current flow through circumferentially opposite pairs of windings is reversed, so that a north pole and a south pole are circumferentially opposite each other about a circumference of the stator.

13. The method according to claim 12, wherein each pair of the windings is wound with a single winding wire.

14. The method according to claim 12, wherein at least two pairs of the windings are wound with a single winding wire to form a coil chain.

15. The method according to claim 12, wherein the stator includes six pairs of windings.

16. A stator for a brushless DC motor including a stator core and circumferentially uniformly spaced stator teeth projecting inwardly from the stator core and leaving a cylindrical inner region exposed, the stator teeth being wound in pairs with a winding wire to form a winding pair by the method of claim 12.

17. A method of manufacturing a polyphase brushless DC motor including a stator and an internal rotor, the stator including uniformly spaced stator teeth which project inwardly from a stator core and leave a cylindrical inner region free, the stator teeth being wound in pairs with a winding wire to form a pair of windings, method comprising winding of each pair of windings by:
starting from a wire beginning of the winding wire, winding a first stator tooth in a first direction;
guiding the winding wire to a second stator tooth which immediately follows the first stator tooth in a first circumferential direction;
winding of the second stator tooth in a second direction opposite to the first direction; and
after the starting, the guiding, and the winding for each pair of the windings:
performing electrically conductive contacting of winding wire ends of each pair of the windings to a contacting device which is energized in operation in such a way that a direction of the current flow through ones of the winding pairs opposite each other in a circumferential direction is reversed, such that in the stator a north pole and a south pole are opposite each other in the circumferential direction.

18. The method according to claim 17, wherein each pair of the windings is wound with a single winding wire.

19. The method according to claim 17, wherein at least two pairs of the windings are wound with a single winding wire to form a coil chain.

20. The method according to claim 17, wherein the stator includes six pairs of windings.

21. The method according to claim 17, wherein the winding wire ends which are to be interconnected to form a single phase extend over a circle sector of about 150° of a circumference of the stator.

22. The method according to claim 17, wherein the inner rotor includes 10-poles.
